(19) United States
(12) Patent Application Publication
(10) Pub. No.: US 2017/0286967 A1
(43) Pub. Date: Oct. 5, 2017

(54) WEARABLE TECHNOLOGY DEVICE-BASED BEHAVIORAL ANALYSIS AND HEURISTIC FEEDBACK

(71) Applicant: International Business Machines Corporation, Armonk, NY (US)

(72) Inventors: Peter A. Balinski, Elmhurst, NY (US); Sasikanth Eda, Andhra Pradesh (IN); John G. Musial, Newburgh, NY (US); Sandeep R. Patil, Pune (IN); Todd R. Whitman, Bethany, CT (US)

(21) Appl. No.: 15/090,713

(22) Filed: Apr. 5, 2016

(51) Int. Cl. G06Q 20/42; H04W 4/00; G06Q 20/40; H04B 1/3827

(52) U.S. Cl. CPC G06Q 20/42; H04B 1/385; H04W 4/008; G06Q 20/40

(57) ABSTRACT

An aspect of wearable technology device processes includes receiving, by a wireless receiver of a wearable technology device, a transaction authorization request and a transaction amount from a contactless transaction terminal. An aspect also includes comparing the transaction amount with a current balance associated with an account of an individual corresponding to the wearable technology device. Upon determining the transaction amount causes the current balance to fall below a limit specified by user-defined settings, an aspect includes retrieving a set of a plurality of tired confirmation prompts from a memory of the wearable technology device, and displaying, via an output component of the wearable technology device a first confirmation prompt from the set. The first confirmation prompt is displayed at a first time interval and before completion of the transaction. Each succeeding confirmation prompt provides increased emphasis in its content or presentation.

### BACKGROUND

The invention relates generally to wearable technology, and more specifically, to wearable technology device-based behavioral analysis and heuristic feedback for behavior modification.

### SUMMARY

According to an embodiment, a method is provided. The method includes receiving, by a computer processor via a wireless receiver of a wearable technology device, an authorization request and transaction amount for a transaction from a contactless transaction terminal. The method also includes comparing the transaction amount with a current balance associated with an account of an individual corresponding to the wearable technology device. Upon determining the transaction amount causes the current balance to fall below a limit specified by user-defined settings, the method further includes retrieving a set of a plurality of tiered confirmation prompts from a memory of the wearable technology device and displaying, via an output component of the wearable technology device, a first confirmation prompt from the set. The first confirmation prompt is displayed at a first time interval and before completion of the transaction. Upon determining at a second time interval that the transaction remains pending, the method also includes displaying via the output component a second confirmation prompt from the set. Each succeeding confirmation prompt in the plurality of tiered confirmation prompts provides increased emphasis in its content or presentation.

Additional features and advantages are realized through the techniques of the invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings, which:

FIG. 1 depicts a system upon which wearable technology device-based behavior analysis and heuristic feedback processes may be implemented in accordance with an embodiment of the invention;

FIG. 2 depicts a block diagram of components of a wearable technology device according to an embodiment;

FIG. 3 depicts a flow diagram of a process for implementing wearable technology device-based behavior analysis and heuristic feedback according to an embodiment of the invention;

FIG. 4A depicts a user interface screen for establishing settings of the wearable technology device-based behavior analysis and heuristic feedback processes according to an embodiment;

FIG. 4B depicts a user interface screen for establishing settings of the wearable technology device-based behavior analysis and heuristic feedback processes according to another embodiment;

FIGS. 5A-5C depict user interface screens of a wearable technology device displaying multi-tiered confirmation prompts according to an embodiment; and

FIG. 6 depicts a simplified wearable technology device according to an embodiment.

### DETAILED DESCRIPTION

Exemplary embodiments are directed to wearable technology device-based behavioral analysis and heuristic feedback for behavior modification (also referred to herein as “wearable device processes”). Wearable technology devices (also referred to herein as “wearable devices”) relate to clothing and accessories that incorporate computer functionality, which in turn, provides one or more specified functions. Examples wearable technology devices include fitness and/or activity trackers, smart watches, jewelry, body cameras, heart rate monitors, global positioning system (GPS) tracking devices, and e-textiles, to name a few.

The exemplary wearable device processes provide a direct method of feedback to an individual to encourage behavioral change and provide a remedial solution to a behavioral disorder. In an embodiment, the wearable device processes utilize a predictive technology framework to identify historical spending trends, and through analysis of these trends provide heuristic feedback to assist individuals in controlling psychological disorders. For instance, the wearable device processes described herein provide functional methods to predict a person's degree of monetary spending relative to his or her defined budget, which indicates underspending, overspending and a need for budget recovery with the goal of encouraging behavior modification of undesirable habits.

The wearable device processes provide a real-time or near real-time assistive technological method in which an individual can be alerted to the symptoms of psychological behaviors, such as overspending. The wearable device processes provide an automated analytic platform for detecting and identifying psychological behavioral patterns when associated with a condition, such as oniomania, and provide real-time feedback to an individual. While financial institutions can determine credit limits and can stop transactions that exceed a limit, they do not relate to or operate with personal budgetary spending limits or other behavioral parameters.

The wearable device processes provide an individually tailored way to determine and indicate to an individual a real-time warning of behavioral conditions such as over spending and compulsive buying.

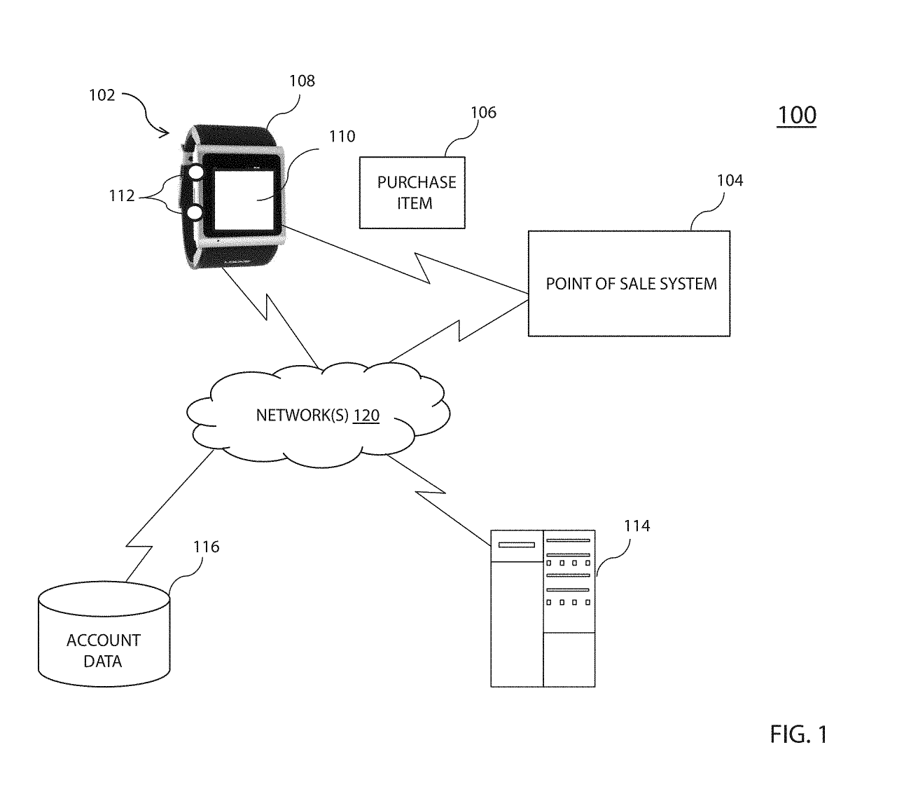

Turning now to FIG. 1, a system 100 upon which the wearable device processes may be implemented will now be described in an embodiment. The system 100 includes a wearable device 102, a point of sale (POS) system 104, a purchase item 106, and one or more network(s) 120.

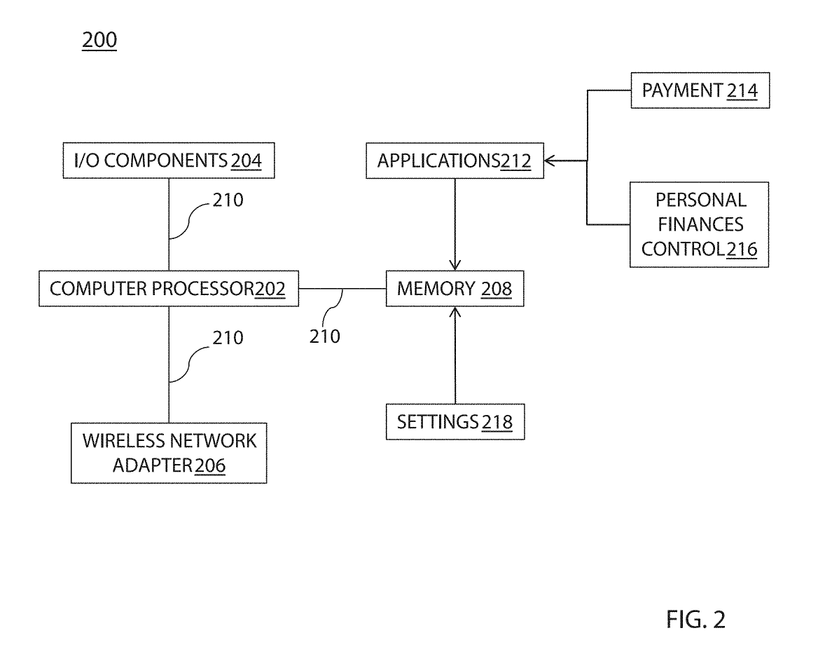

The wearable device 102 is shown in FIG. 1 as a smart watch by way of non-limiting example. The wearable device 102 includes a fastening strap 108, a display 110, and input controls 112. A detailed description of the components of the wearable device 102 is provided further in FIG. 2.

The POS system 104 may be implemented by a merchant or service provider. In an embodiment, the POS system 104 is a contactless payment terminal that utilizes wireless communication protocols (e.g., BLUETOOTH™ or near field communication (NFC) technologies) to negotiate transactions conducted over the network(s) 120 among the wearable device 102, the POS system 104, and a financial institution that services an account of a user of the wearable device 102. In an embodiment, the individual who is wearing the wearable device 102 acquires a purchase item 106 and approaches the POS system 104 in preparation for a purchase transaction.

The networks 120 may be implemented as a combination of one or more different types of networks (e.g., local area network, wide area network, Internet, satellite, or terrestrial network, to name a few).

Also included in the system 100 are a financial institution server computer 114 (also referred to herein as “financial server”) and a storage device 116. In an embodiment, the financial server 114 manages one or more financial accounts (e.g., as a banking institution) of the user of the wearable device 102. The financial accounts may include credit and/or debit accounts. The financial server 114 may be implemented as a high-speed computer processing device for handling the volume of activities associated with financial transactions with respect to its account holders. The financial server 114 is communicatively coupled to one or more of the networks 120 to process account transactions that occur between the user of the wearable device 102 and the POS system 104. In an embodiment, the financial server 114 may be capable of communicating directly with the wearable device 102 over one or more of the networks 120.

While only a single POS system 104 and a single financial server 114 are shown in FIG. 1 for ease of illustration and description, it will be understood that multiple POS systems and/or financial institutions may be employed to realize the advantages of the embodiments described herein. For example, an individual may hold multiple accounts at multiple different financial institutions, and may also engage in transactions with multiple different merchants. The exemplary wearable device processes described herein can accommodate purchase activities conducted by an individual across different merchants or enterprises, and may use multiple different financial accounts.

The storage device 116 is communicatively coupled to the financial server 114. The storage device 116 may be implemented using a variety of devices for storing electronic information. It is understood that the storage device 116 may be implemented using memory contained in the financial server 114 or it may be a separate physical device, as illustrated in FIG. 1. The storage device 116 may be logically addressable as a consolidated data source across a distributed environment that includes one or more networks, such as networks 120. Information stored in the storage device 116, such as account data, is retrieved and manipulated via the financial server 114.

FIG. 2 illustrates components of a wearable device 200 in accordance with an embodiment. While the components of the wearable device 200 are described with respect to features directed to assisting in the control of monetary spending with respect to personalized budgetary limits, it will be understood that other behavior modification features may be employed by the wearable devices processes to realize the advantages of the embodiments described herein. For example, in one embodiment, other behaviors may include compulsive eating, in which the processes apply pre-purchase prompts when food items are subject to purchase irrespective of an individual's budget. It is understood that these behavior modification controls can be combined as well (e.g., compulsive eating controls and spending limits) such that an individual may establish settings to simultaneously address both aspects of his/her behavior.

The wearable device 200 corresponds to the wearable device 102 of FIG. 1, although the wearable device 200 is not restricted to a smart watch but may comprise other types of wearable technology devices. The wearable device 200 includes a computer processor 202, input/output (I/O) components 204, a wireless network adapter 206, and a memory 208, each of which are communicatively coupled to one another via a communication bus 210.

The I/O components 204 may vary depending upon the type and complexity of wearable device. For example, I/O components 204 of a simplified wearable device may include light emitting diodes (LEDs) and one or more input control buttons. A sample, simplified wearable device is shown and described in FIG. 6. By contrast, I/O components of an advanced wearable device may include a multi-media display screen, touch screen, audio speakers, and/or voice microphone, to name a few. The input controls 112 of FIG. 1 and the display (output component) 110) illustrate one example of the I/O components 204. It is understood that wearable devices may include any combination of I/O components 204, as well as other features.

The wireless network adapter 206 provides a communications interface between the wearable device and external devices and systems. The wireless network adapter 206 may include a transceiver for receiving and sending wireless communications, and may be configured with various communication protocols (e.g., BLUETOOTH™, NFC, etc.) to handle different types of communications. In an embodiment, the wireless network adapter 206 may be configured to send and receive communications over larger, long distance networks, such as one or more of networks 120.

The memory 208 stores one or more applications 212, which are executable by the computer processor 202 to provide various features and functions of the wearable device 200. For example, if the wearable device is an activity tracker, an application (not shown) may process acceleration or movement data from a component (e.g., an accelerometer—not shown) of the wearable device and provide information about frequency of activity, duration, and other patterns of movement. In one embodiment, the memory 208 may store financial account information of a user, such as current balance information. The current balance information can be acquired by the device 200, e.g., through direct communication between the device 200 and the financial server 114. In an embodiment, the current balance may be stored in a registered cloud storage facility that is accessible to the wearable device, e.g., through an access-controlled security scheme, and periodically synchronized with the current balance in the memory 208.

As shown in FIG. 2, a payment application 214 and personal finances control application 216 are stored in the memory 208. The payment application 214 facilitates payment transactions between a user of the wearable device 200 and the POS system 104. In an embodiment, the payment application 214 includes an authentication feature and digitized account information of an account of the user. The user may pre-register with one or more financial institutions (e.g., the financial server 114) to establish payment transaction capabilities through the wearable device 200. Although the particular method of authentication may vary among devices, in an embodiment, the user may swipe a display screen of the device 200 or activate the payment application 214 through one or more input controls of the I/O components 204.

The personal finances control application 216 may be stored as a separate application from the payment application 214, in which the personal finances control application 216 may be implemented as a plug-in to the payment application 214 or an extension thereof. Alternatively, the functions provided by the personal finances control application 216 may be integrated with the payment application 214 as a single software application. The personal finances control application 216 receives transaction information and initiates one or more confirmation prompts in response thereto. These prompts are described further herein.

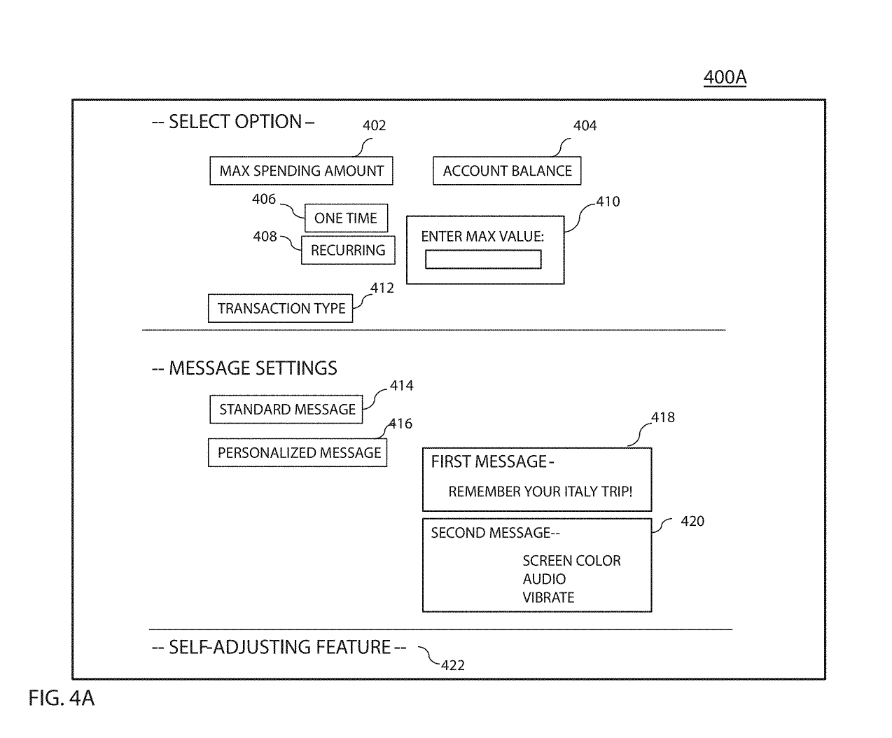

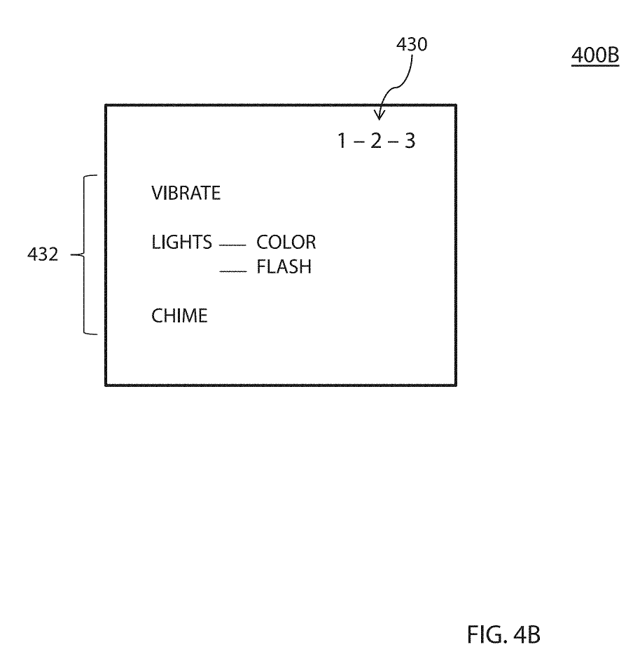

In an embodiment, various settings 218 are also stored in the memory 208 and are retrievable by the computer processor 202 to determine when and how to initiate a confirmation prompt. In one embodiment a user of the wearable device 200 configures at least a portion of the settings 218, e.g., via an I/O component 204. A sample user interface for establishing these settings with respect to a complex wearable device is shown generally in FIG. 4A, while a sample user interface for establishing settings with respect to a simplified wearable device is shown generally in FIG. 4B. The settings 218 are configured to initiate a plurality of multi-tiered confirmation prompts to the user in response to transaction activities conducted by the user. Each successive tier of confirmation prompts provides a greater degree or emphasis on urgency with respect to its content and/or presentation. The content may include directed messages that express increasing levels of urgency with each instantiation. In addition, the frequency or number of prompts presented, as well as the manner of presentation, may be proportionate to the amount of spending and/or budgetary limits that are set by an individual. These features are described further herein.

As wearable devices may differ in their features offered, it will be understood that other components may be added to the components shown in FIG. 2. For example, other components may include a web browser application, a global positioning system, health monitoring sensors (e.g., heart rate monitor), fitness and/or activity tracker, scanner (e.g., bar code, quick response (QR) code), camera, etc.

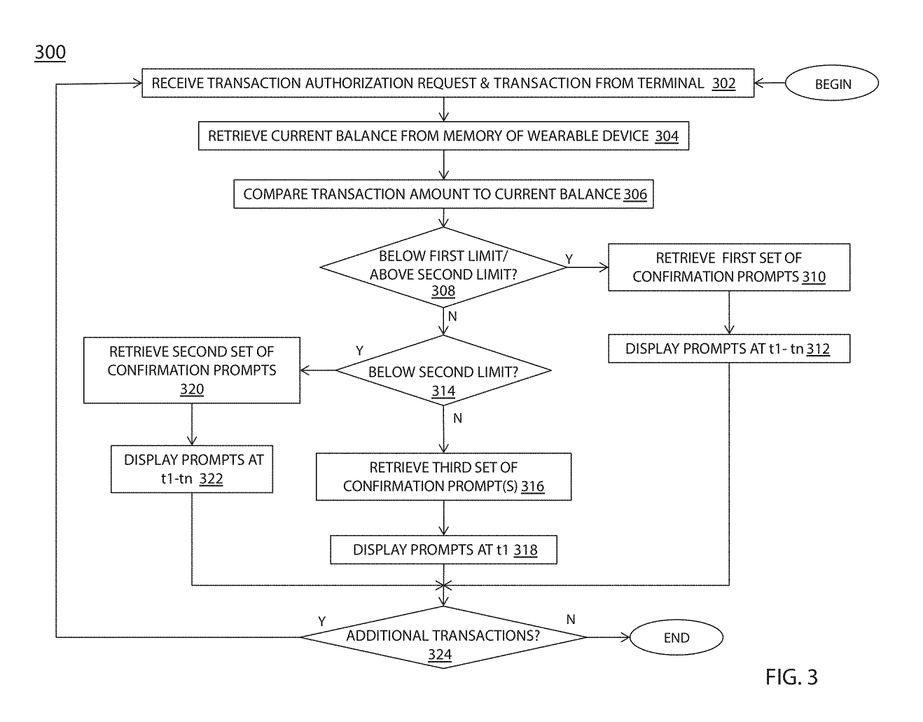

Turning now to FIG. 3, a flow diagram 300 illustrating the wearable device processes will now be described in an embodiment. The processes described in FIG. 3 assume that a user of a wearable device (e.g., wearable device 102/200) is in communication with a POS system (e.g., POS system 104), the user has acquired a purchase item 106, and that the wearable device 102/200 is payment enabled, e.g., via the payment application 214. The processes also assume that the user has configured settings (settings 218) either through the I/O components 204 of the device or through a web-based process external to the wearable device. These settings 218 enable the user to establish conditions upon which confirmation prompts will be delivered to the wearable device. Multiple different limits may be set for different monetary conditions and/or limits can be set based on types or categories of purchases. A sample interface for establishing the settings 218 is shown in FIGS. 4A-4B.

By way of example, suppose the user has configured two limits that relate to the user's current balance with respect to a financial account. The user's current balance in the account is $500. The user identifies a first limit and a second limit. In an example, the first limit is $100 and the settings indicate that should an initiated transaction cause the user's current balance to fall below $100, a first set of confirmation prompts will be retrieved from the memory 208 and presented to an output component of the wearable device at designated time intervals. The second limit, by way of illustration, is set at $50, and the settings indicate that should an initiated transaction cause the user's balance to fall below $50, a second set of confirmation prompts will be retrieved from the memory 208 and presented to an output component of the wearable device at designated time intervals. The first set of confirmation prompts reflects a number of tiered confirmation prompts, where each succeeding prompt in the set of tiered confirmation prompts demonstrates increasing emphasis on urgency in its content and/or presentation. The second set of confirmation prompts also reflects a number of tiered confirmation prompts, where each succeeding prompt in the set of tiered confirmation prompts demonstrates increasing emphasis on urgency in its content and/or presentation. However, the second set of confirmation prompts differ from the first set of confirmation prompts in number, frequency of presentation, content and/or presentation. For example, the second set of confirmation prompts may include two prompts presented against a selected color background and may be presented at intervals of 15 seconds, while the third set of confirmation prompts may include greater than two prompts presented against a different color background and may be presented at intervals of 10 seconds (or in intervals of increased frequency for each successive prompt). It will be understood that the above illustrates a single example of the type of settings that may be employed. It is understood that many variations may be applied, e.g., instead of a limit set based on a current balance, the user may set a total spending limit regardless of the user's account balance. These settings 218 are described further in FIGS. 4A-4B.

The process begins in block 302, when a wireless receiver (e.g., network adapter 206) of the wearable device 102/200 receives a transaction authorization request and transaction data from a contactless transaction terminal (e.g., POS system 104). The transaction data may include a transaction amount and may optionally include a transaction description (e.g., type of goods subject to purchase). In an embodiment, the transaction amount can be gleaned from scanning a bar code of the purchase item by a scanning device at the point of sale system, or if the wearable device 200 is configured with a bar code scanner, the device 200 may scan the purchase item.

In block 304, the computer processor 202 (e.g., via the personal finances control application 216) retrieves a current balance from the memory 208 of the wearable device. In an embodiment, the wearable device 200 may contact the financial server 114 directly (e.g., over networks 120) via the wireless network adapter 206 and store this information in memory 208. In an alternative embodiment, the current balance can be provided by the financial server to a registered storage facility in which the user holds an account, such that the information is available to the wearable device. The wearable device can periodically synch with the financial server and/or registered storage facility to update the account balance as it changes over time.

In block 306, the computer processor 200 compares the transaction amount to the current balance.

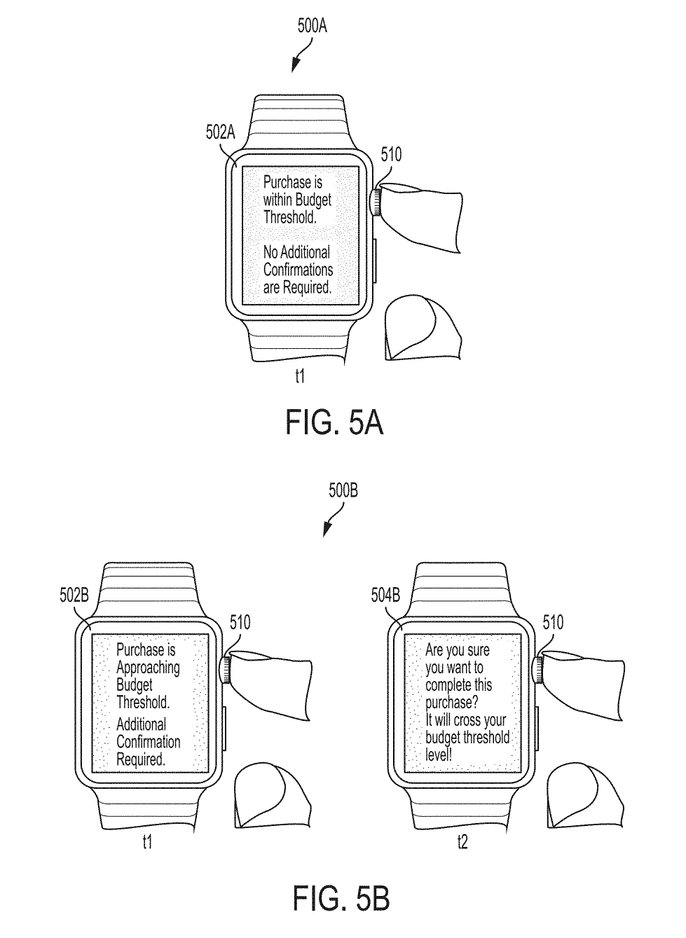

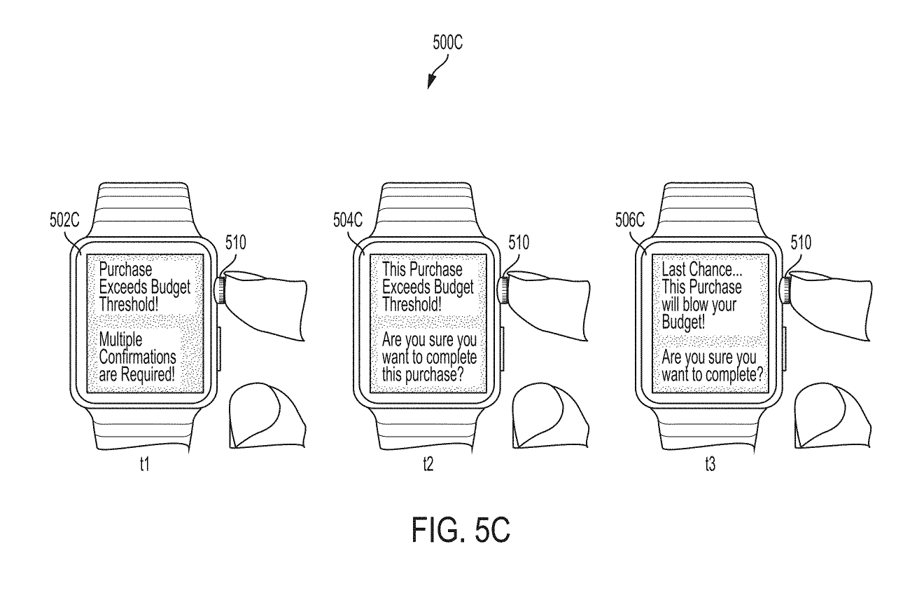

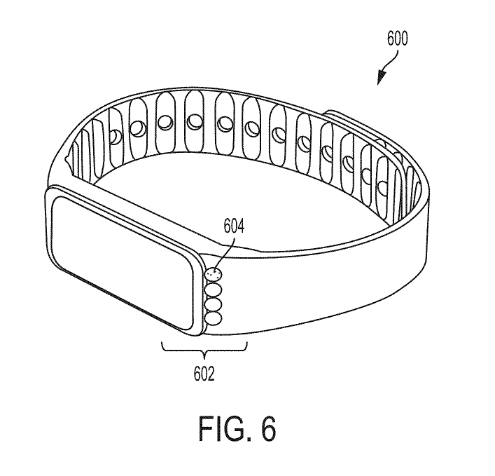

In block 308, the computer processor 202 determines whether the transaction, if executed, will cause the current balance to fall below a first limit (but above a second limit). Using the example above, if the user's current balance is $500, the process determines whether the transaction amount will cause the current below to fall below the first limit of $100. This limit may be established based on the user's comfort level insofar as he or she would like to retain a minimum balance or range in the balance. The first limit may be established for notifying the user that if this purchase is completed, the user's balance will fall below that balance. Thus, if the transaction will cause the current balance to fall below the first limit, the processor 202 retrieves a first set of confirmation prompts (also referred to herein as a second tier of confirmation prompts) from the memory 208 and presents a first confirmation prompt from the first set on an output component of the wearable device at block 312. As shown, e.g., in FIG. 5B, the first confirmation prompt is shown on a display 502B at a first time interval, t1. The display 502B corresponds to the display 110 of FIG. 1. Upon passage of a defined period of time (e.g., as configured in the settings 218), and before completion of the transaction subject to the request, the computer processor 202 presents a second confirmation prompt from the first set on an output component of the wearable device. As shown, e.g., in FIG. 5B, the second confirmation prompt is shown on a display 504B at a second time interval, t2. The display 504B corresponds to the display 110 of FIG. 1. The process 300 proceeds to block 324.

If, however, the transaction does not cause the current balance to fall below the first limit, the computer processor 202 determines whether the transaction will cause the current balance to fall below a second limit at block 314 (e.g., where the second limit relates to a value of the current balance that is lower than a value associated with the first limit). Using the example above, the second limit is set at $50, which is lower than the first limit of $100. In this scenario, a different set (e.g., a second set) of prompts are used (as compared to when the first limit is reached) to provide a greater sense of urgency, as the user's account balance will be more significantly impacted by the purchase. Thus, if the transaction will cause the current balance to fall below the second limit, the computer processor 202 retrieves the second set of confirmation prompts (also referred to herein as a third tier of confirmation prompts) from the memory in block 320 and presents a first confirmation prompt from the second set of prompts on an output component of the wearable device at a first time interval, t1, at block 322. As shown in FIG. 5C, the first confirmation prompt is shown in a display 502C at a first time interval, t1. The display 502C corresponds to the display 110 of FIG. 1.

Upon passage of a defined period of time (e.g., as configured in the settings 218), and before completion of the transaction subject to the request, the computer processor 202 presents a second confirmation prompt from the second set on an output component of the wearable device. As shown, e.g., in FIG. 5C, the second confirmation prompt is shown on a display 504C at a second time interval, t2. The display 504C corresponds to the display 110 of FIG. 1. Since the second limit would significantly reduce the user's current balance, the settings 218 provide for a third confirmation prompt in the second set of confirmation prompts. Thus, upon passage of another defined period of time, and before completion of the transaction, the computer processor 202 presents the third confirmation prompt on an output component of the wearable device at a third time interval, t3. As shown in FIG. 5C, the third confirmation prompt is shown in a display 506C at a third time interval, t3. The display 506C corresponds to the display 110 of FIG. 1. The process proceeds to block 324.

If, however, the transaction will not cause the current balance to fall below the second limit, this means that the user's current balance will not be negatively impacted by the transaction. In this instance, the computer processor 202 retrieves a confirmation prompt from a first tier of confirmation prompts in the memory in block 316 and presents the confirmation prompt on from the first tier on an output component of the wearable device at block 318. As shown in FIG. 5A, a confirmation prompt associated with the first tier is shown in a display 502A at a first time interval. The display 502A corresponds to the display 110 of FIG. 1.

In block 324, the computer processor 202 determines whether any additional transactions have been initiated by the individual associated with the wearable device. If so, the process returns to block 302. Otherwise, the process 300 ends.

The multi-tiered confirmation prompts, delivered in succession and with increased urgency in content or presentation, facilitate a delay in the process of the ongoing transaction while allowing the user additional time to contemplate the behavior before the transaction is completed. In addition, the multi-tiered confirmation prompts are configured to increase in urgency at a proportionately higher rate as the user's attempted transaction progresses to a threshold that is in opposition of the desired behavioral changes. For instance, using the example of purchase transactions, the confirmation prompts can proceed in greater frequency and in urgency when a base monetary limit or threshold is approached or reached if the transaction was completed.

Thus, where the transaction comprises a purchase of an item by the individual associated with the wearable device and the contactless transaction terminal is a point of sale system, the wearable device determines, via wireless communication from the contactless terminal, an amount of the transaction. In an embodiment, the personal finances control application 216 compares the amount of the transaction to a monetary value stored in the memory of the wearable device, which monetary value indicates a spending limit with respect to a financial account of the individual. For example, the monetary value may represent a spending limit for a single purchase, a total amount spent over a defined period of time, or a monetary amount reflecting a percentage of a debit or credit balance of the financial account.

The spending limits or monetary value can be configured by the user to apply to certain categories of purchases, such as electronics, foods, dining, clothing, etc. Other topics of behavior modification that can be applied using the wearable device processes include, e.g., overeating.

In an embodiment, the wearable device processes may include self-adjusting features (see, generally option 422 of FIG. 4). The self-adjusting features enable the monitoring of ongoing transactions and responses to the confirmation prompts by the user, determine trends and patterns of transaction activities by the individual over time based on the monitoring, and automatically adjust a timing, frequency, and/or content of the confirmation prompts based on the trends and patterns. For example, suppose the user aborted five consecutive transaction in which a second limit confirmation prompt was delivered, this indicates desired behavior change in the user. The self-adjusting features can be configured to decrease the frequency, number, and/or urgency in content or presentation of the confirmation prompts. The self-adjusting features can also include messages of positive reinforcing content when desired behavioral changes are determined. In another example, the self-adjusting features can monitor the progress or lack thereof (e.g., via completed transactions occurring when a second limit is reached) and provide summarized information about the user's progress over time.

As shown in FIGS. 4A and 4B, user interface screens 400A and 400B, respectively, enable a user to configure the settings 218 (FIG. 2) based on the type of wearable device. In the user interface screen 400A, the user may select options for defining conditions for initiating confirmation prompts for one or more purchase transactions.

As shown in FIG. 4A, the user can set a maximum spending amount through an option 402, which can be further configured as a one-time only (e.g., for one purchase or shopping trip) via option 406, or may be recurring via option 408. The actual spending limit (monetary value) can be entered via option 410. Alternatively, the user may select the option 404 (account balance), which enables the wearable device 102 to directly access a current account balance in determining whether a limit has been exceeded. For example, suppose the user would like to be reminded if a prospective purchase will cause his or her account balance to fall below a specified threshold. In addition, as indicated above, the user may configure which types of purchases are subject to the wearable device processes, and therefore, limits. This feature can be implemented via option 412.

In addition to the above, other configurable settings include standard message settings via option 414 and personalized message settings via option 416. In option 414, the user allows the personal finances control application 216 to identify and retrieve the pre-set confirmation prompts. In option 418, a user may configure his or her own confirmation prompt, e.g., which can be tailored to a particular meaningful message or situation. As shown in windows 418 and 420, each message in a multi-tiered confirmation process can be separately customized by the user. In window 418, e.g., the user selects for the first delivered message to provide a custom message that reminds the user of an upcoming trip that the user is saving money for. In window 420, the user configures how the second message of the multi-tiered confirmations will be presented (e.g., screen color selection, audio confirmation, vibrate, etc.).

The self-adjusting feature 422, upon selection by the user, enables the processes to monitor transaction activities to determine whether the confirmations have proven successful (e.g., the user initiates a purchase transaction, receives a first (and optionally a subsequent) confirmation prompt, and no completed transaction is detected by the processor (e.g., the payment application 214 provides no information that the transaction was successfully completed). The self-adjusting feature 422 can then modify future confirmation prompts based on the success or lack thereof of the messages in order to motivate or promote desired behaviors of the user.

In FIG. 4B, a simplified user interface 400B (e.g., a simple fitness tracker with a small display screen and minimal input controls) enables a user to select from 3 tiered confirmation prompts via option 430. With each selection, the user may then enter from a group 432 of confirmation prompt options. As an example, the user may select vibrate as the first confirmation prompt and chime as a second confirmation prompt.

Turning now to FIGS. 5A-5C, wearable devices 500A-500C include messages that vary based on the particular details of the initiated transaction. In FIG. 5A, device 500A displays a message 502A in which the user has not exceeded any identified purchase limits. The message in this instance may be provided against a first color display screen (e.g., green) to indicate the purchase is acceptable according to the configured settings.

In FIG. 5B, device 500B is shown at two different points in time (t1 and t2, respectively). At t1, a first confirmation prompt 502B is presented to the user (e.g., against a second color display screen (e.g., yellow) to indicate the user is approaching a limit). The user may select an input control button 510 to acknowledge the prompt. If the transaction is not aborted by the user, a second confirmation prompt 504B is presented to the user (e.g., against the second background). Again the user may select input control option 510 to acknowledge the prompt. As shown by way of non-limiting illustration, the user is presented with two separate prompts instead of one because the user's limit is close to being met.

In FIG. 5C, device 500C is shown at three different points in time (t1, t2, and t3, respectively). At t1, a first confirmation prompt 502C is presented to the user (e.g., against a third color display screen (e.g., red) to indicate the user has reached or exceeded a limit). The user may select an input control button 510 to acknowledge the prompt. If the transaction is not aborted by the user, a second confirmation prompt 504C is presented to the user (e.g., against the third color background) at t2. The user may select input control option 510 to acknowledge the prompt. At t3, a third confirmation prompt 506C is presented to the user (against the third color background). The user may select input control button 510 to acknowledge receipt of the prompt. As shown by way of example, the user is presented with three separate prompts instead of one because the user's limit is reached or exceeded.

In FIG. 6, a wearable device 600 having simplified components may be configured to provide confirmation prompts using LEDs 602 disposed on the device. Each successive prompt may be presented as a different color 604 or may be implemented by quick flashing to steady state (non-flashing) to reflect the different tiers of prompt.

Technical effects and benefits of a wearable technology device provide a real-time or near real-time assistive technological method in which an individual can be alerted to the symptoms of psychological behaviors, such as overspending. The wearable device processes provide an automated analytic platform in which one can detect and identify psychological behavioral patterns when associated with a condition, such as oniomania, and provide real-time feedback to an individual.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving, by a computer processor via a wireless receiver of a wearable technology device, an authorization request and transaction amount for a transaction from a contactless transaction terminal;
comparing the transaction amount with a current balance associated with an account of an individual corresponding to the wearable technology device;
upon determining the transaction amount causes the current balance to fall below a limit specified by user-defined settings, retrieving a set of a plurality of tiered confirmation prompts from a memory of the wearable technology device;
displaying, via an output component of the wearable technology device, a first confirmation prompt from the set, the first confirmation prompt displayed at a first time interval and before completion of the transaction; and
upon determining at a second time interval that the transaction remains pending, displaying via the output component a second confirmation prompt from the set;
wherein each succeeding confirmation prompt in the plurality of tiered confirmation prompts provides increased emphasis in its content or presentation.

2. The method of claim 1, wherein the limit is a first limit and the set of the plurality of tiered confirmation prompts is a first set, the method further comprising:
upon determining the transaction amount causes the current balance to fall below a second limit in the user-defined settings, the second limit being lower than the first limit, retrieving a second set of the plurality of tiered confirmation prompts from the memory, the second set of the plurality of tiered confirmation prompts being greater in number than the first set, and each successive confirmation prompt in the second set of tiered confirmation prompts is displayed via the output component at increased frequency.

3. The method of claim 1, further comprising:
receiving updates to the current balance from a registered data storage facility over a network.

4. The method of claim 1, further comprising:
storing transaction data in the memory for previously conducted transactions, a portion of the previously conducted transactions executed via the wearable technology device and another portion of the previously conducted transactions executed outside of the wearable technology device, the transaction data for the other portion of the previously conducted transactions received at the wearable technology device through a network-based synching mechanism.

5. The method of claim 1, further comprising:
wherein the user settings include a plurality of different spending limits that are defined for each of a plurality of purchase categories.

6. The method of claim 1, further comprising:
monitoring ongoing transactions and responses to the confirmation prompts, the responses including completed transactions and aborted transactions;
identifying trends and patterns of transaction activities by the individual over time based on the monitoring; and
automatically adjusting at least one of a timing, frequency, and content of the confirmation prompts based on the identified trends and patterns.

7. The method of claim 1, wherein the wearable device is at least one of a fitness tracker, activity tracker, health monitor, smart watch, and e-textile.

8. A wearable technology device comprising an article and a means for removably attaching the article to an individual, the wearable technology device comprising:
a wireless network adapter;
an output component;
a memory having computer readable instructions, the memory storing user-defined settings and a plurality of tiered confirmation prompts, wherein each succeeding confirmation prompt in the tiered confirmation prompts provides increased emphasis in its content or presentation; and
a processor for executing the computer readable instructions, the computer readable instructions including:
receiving, via the wireless network adapter of the wearable device, an authorization request and transaction amount for a transaction from a contactless transaction terminal;
comparing the transaction amount with a current balance associated with an account of the individual;
upon determining the transaction amount causes the current balance to fall below a limit in the user-defined settings, retrieving a set of the plurality of tiered confirmation prompts from the memory;
displaying via the output component a first confirmation prompt from the set, the first confirmation prompt displayed at a first time interval and before completion of the transaction; and
upon determining at a second time interval that the transaction remains pending, displaying via the output component a second confirmation prompt from the set.

9. The wearable technology device of claim 8, wherein the limit is a first limit and the set of the plurality of tiered confirmation prompts is a first set, the computer readable instructions further comprise:
upon determining the transaction amount causes the current balance to fall below a second limit in the user-defined settings, the second limit being lower than the first limit, retrieving a second set of the plurality of tiered confirmation prompts from the memory, the second set of the plurality of tiered confirmation prompts being greater in number than the first set, and each successive confirmation prompt in the second set of tiered confirmation prompts is displayed via the output component at increased frequency.

10. The wearable technology device of claim 8, wherein the computer readable instructions further comprise:
receiving the current balance from a registered data storage facility over a network.

11. The wearable technology device of claim 8, further comprising an input component, wherein the computer readable instructions further comprise:
receiving the user settings via the input component of the wearable device.

12. The wearable technology device of claim 8, wherein the user settings include a plurality of different spending limits that are defined for each of a plurality of purchase categories.

13. The wearable technology device of claim 8, wherein the computer readable instructions further include:
monitoring ongoing transactions and responses to the confirmation prompts, the responses including completed transactions and aborted transactions;
identifying trends and patterns of transaction activities by the individual over time based on the monitoring; and
automatically adjusting at least one of a timing, frequency, and content of the confirmation prompts based on the identified trends and patterns.

14. The wearable technology device of claim 8, wherein the article is at least one of a fitness tracker, activity tracker, health monitor, smart watch, and e-textile.

15. A computer program product comprising a computer readable storage medium having program instructions embodied therewith, wherein the computer readable storage medium is not a transitory signal per se, the program instructions executable by a computer processor of a wearable technology device to cause the computer processor to perform a method comprising:
receiving, by a computer processor via a wireless receiver of a wearable technology device, an authorization request and transaction amount for a transaction from a contactless transaction terminal;
comparing the transaction amount with a current balance associated with an account of an individual corresponding to the wearable technology device;
upon determining the transaction amount causes the current balance to fall below a limit specified by user-defined settings, retrieving a set of a plurality of tiered confirmation prompts from a memory of the wearable technology device;
displaying, via an output component of the wearable technology device, a first confirmation prompt from the set, the first confirmation prompt displayed at a first time interval and before completion of the transaction; and
upon determining at a second time interval that the transaction remains pending, displaying via the output component a second confirmation prompt from the set;
wherein each succeeding confirmation prompt in plurality of tiered confirmation prompts provides increased emphasis in its content or presentation.

16. The computer program product of claim 15, wherein the limit is a first limit and the set of the plurality of tiered confirmation prompts is a first set, the method further comprising:
upon determining the transaction amount causes the current balance to fall below a second limit in the user-defined settings, the second limit being lower than the first limit, retrieving a second set of the plurality of tiered confirmation prompts from the memory, the second set of the plurality of tiered confirmation prompts being greater in number than the first set, and each successive confirmation prompt in the second set of tiered confirmation prompts is displayed via the output component at increased frequency.

17. The computer program product of claim 15, wherein the program instructions are further executable to perform:
receiving the current balance from a registered data storage facility over a network.

18. The computer program product of claim 15, wherein the program instructions are further executable to perform:
storing transaction data in the memory for previously conducted transactions, a portion of the previously conducted transactions executed via the wearable technology device and another portion of the previously conducted transactions executed outside of the wearable technology device, the transaction data for the other portion of the previously conducted transactions received at the wearable technology device through a network-based synching mechanism.

19. The computer program product of claim 15, wherein the user settings include a plurality of different spending limits that are defined for each of a plurality of purchase categories.

20. The computer program product of claim 15, monitoring ongoing transactions and responses to the confirmation prompts, the responses including completed transactions and aborted transactions;
identifying trends and patterns of transaction activities by the individual over time based on the monitoring; and
automatically adjusting at least one of a timing, frequency, and content of the confirmation prompts based on the identified trends and patterns.
